(19) United States
(12) Patent Application Publication
(10) Pub. No.: US 2018/0304822 A1
(43) Pub. Date: Oct. 25, 2018

(54) TRIM PART WITH INTEGRATED ANTENNA

(71) Applicant: Dura Automotive Holdings U.K., Ltd, Birmingham (GB)

(72) Inventors: Martin Schulte, Balve (DE); Jochen Schulze Zur Wiesche, Koln (DE)

(21) Appl. No.: 15/961,036

(22) Filed: Apr. 24, 2018

(30) Foreign Application Priority Data
Apr. 25, 2017 (EP) 17168011.9
Aug. 22, 2017 (EP) 17187330.0

(51) Int. Cl. B60R 11/02; B60R 13/04; H01Q 1/32; H01Q 1/12

(52) U.S. Cl. CPC B60R 11/02; B60R 13/04; B60R 2011/005; H01Q 1/1214; H01Q 1/3275

(57) ABSTRACT

In order to provide an enhanced functional range for an external trim part of a motor vehicle relative to known trim parts, without impairing the decorative function of the trim part relative to non-functionally enhanced trim parts, it is provided that an antenna is retained by a sandwich-type connection between a decorative part and a carrier part of the trim part or that an antenna is retained on the inner face of the carrier part facing the bodywork in the installed state as intended.

### CROSS-REFERENCE TO RELATED APPLICATIONS

This application claims priority to European Application serial numbers EP 17168011.9 filed on Apr. 25, 2017 and EP 17187330.0 filed on Aug. 22, 2017. The entire disclosure of the above applications are hereby incorporated by reference.

### FIELD

The present disclosure relates generally to a trim part for a motor vehicle, in particular a trim part configured as a strip component.

### BACKGROUND

The statements in this section merely provide background information related to the present disclosure and may or may not constitute prior art.

Trim parts of this type are disclosed, for example, in EP 2 450 240 B1 or in EP 1 695 808 B2. These trim parts are designed as strip components and consist of a plurality of components, wherein one component (the decorative part) undertakes a substantially decorative function and a further component (the carrier part) is concealed by the decorative part and substantially performs technical tasks, namely the support of sealing elements or the formation of fastening elements for cooperating with the bodywork and/or for attaching to the bodywork. However, with the exception of a few mechanical functions, the main function of such strip components is limited to a purely decorative function.

### SUMMARY

The invention relates to a trim part for a motor vehicle, in particular a trim part configured as a strip component, comprising an external decorative part and an internal carrier part which is connected to the decorative part in order to form together the trim part, wherein the decorative part is produced from a decorative material and, when the trim part is attached as intended to the motor vehicle, forms a decorative surface which faces away from the bodywork and which determines the appearance of the visible surfaces of the motor vehicle, and wherein the carrier part is produced from a carrier material which is preferably different from the decorative material and faces the bodywork when the trim part is attached as intended to the motor vehicle. Trim parts of this type, in particular, may be pillar finishers (A-, B-, C- or D-pillar finishers), aero panels, spoilers, cowls or facings of windshield frames. The invention further relates to a method for producing such a trim part.

A trim part of the type mentioned in the introduction is intended to be developed such that said trim part has an enhanced functional range relative to known trim parts. In particular, the trim part is intended to fulfil functions which go beyond the previous functions for which it was predestined, due to its typically strip-like, longitudinally extending and flat structural design, its construction and its positioning on the motor vehicle. At the same time, the decorative function of the trim part is not intended to be impaired relative to non-functionally enhanced trim parts.

The invention provides that, in addition to the decorative part and the carrier part, an antenna is retained by a sandwich-type connection between the decorative part and the carrier part or that the antenna is retained on the inner face of the carrier part facing toward the bodywork in the installed state as intended. With regard to the method for producing such a trim part, the invention is achieved by the features described in the claims.

In this case, in particular, it may be provided that the attachment of the decorative material to the carrier material and/or the attachment of the carrier material to the decorative material is carried out by attaching the decorative material and/or the carrier material to the joining surface of the carrier part and/or of the decorative part and the antenna fastened to the respective antenna carrier portion in an injection-moulding process.

The invention, therefore, fulfils the increasing need for assistance systems, multimedia systems and mobile communications systems in vehicles, by which the need for aids which are additionally accommodated in the vehicle and which permit a comprehensive use of such systems is significantly increased. The typical positioning of such external trim parts, such as pillar finishers (A-, B-, C- or D-pillar finishers), aero panels, spoilers, cowls or facings of windscreen frames, is almost perfect for the use of antennae due to their arrangement on the vehicle, as well as the flat-elongated design. Since a plurality of such trim parts are arranged spatially separated from one another on the vehicle, the influence of different antennae relative to one another may be substantially excluded. Moreover, the construction of such external trim strips ensures a sufficiently large spacing from adjacent metal (structural) components. As a whole, the spatial position on the motor vehicle and the construction of trim parts from a plurality of components (decorative part and carrier part) are excellent prerequisites for the integration of antennae on the motor vehicle.

It is provided that the decorative material and the carrier material differ from one another. The decorative material of the decorative part is preferably a thermoplastic material which is suitable for forming a scratch-resistant, high-gloss decorative surface as an external decorative and visible surface. In particular, PMMA is considered as a material. The carrier material of the carrier part is, in particular, a thermoplastic material with high mechanical strength and good impact resistance, and is suitable for forming functional components such as fastening means, clip connections, screw holes for self-tapping screws or the like. In particular, ABS or PC-ABS may be possible as the material.

The trim part is preferably an external trim part, i.e. a trim part which is arranged on the vehicle outer face of the body shell in the installed state as intended. As already mentioned, this component may be, in particular, a pillar finisher (A-, B-, C- or D-pillar finisher), an aero panel, a spoiler, a cowl or a facing of a windscreen frame.

It is preferably provided that the decorative part and the carrier part bear against one another in a planar manner, wherein the antenna in this case may be arranged in a sandwich-type connection between the decorative part and the carrier part. To this end, the antenna is preferably also configured to be planar, in particular in a film-like manner.

The antenna may be retained in a clamped manner between the decorative part and the carrier part. The decorative part and the carrier part may be connected positively together, in particular via mechanical connecting members. In particular, latching elements which correspond to one another may be provided on the decorative part and carrier part, the decorative part and carrier part being able to be secured to one another thereby. The antenna may be retained, in particular, in a sandwich-type connection between the decorative part and the carrier part, wherein the surface portions of the decorative part and carrier part facing the antenna are preferably in direct contact with the antenna which is preferably configured as a film antenna and/or bear against the antenna on both sides of the antenna without clearance.

In particular, it may also be provided that the decorative part and the carrier part are connected together by a material connection so as to encompass the antenna. The decorative part and the carrier part may, in particular, be adhesively bonded or welded together, wherein different welding methods such as laser welding, friction welding or ultrasonic welding may be used. In order to connect together the decorative part and the carrier part by a material connection enclosing the antenna, it is also possible that initially the decorative part is produced from the decorative material and subsequently a joining surface of the decorative part and the antenna, which has been previously positioned thereon on an antenna carrier portion, is injection-moulded above and below or flooded by the material of the carrier part, so that the antenna is enclosed in a sandwich-type connection between the decorative part and/or decorative material and the carrier part and/or carrier material.

It is also conceivable that initially the carrier part is produced from the carrier material, then the antenna is arranged on the carrier part on an antenna carrier portion of the carrier part facing the decorative part, and subsequently the decorative material is applied to a joining surface adjacent to the antenna carrier part and the antenna, enclosing the antenna in a sandwich-type connection between the carrier material and the decorative material.

Such a production is preferably able to be carried out inside an injection-moulding tool during the course of a multi-component injection-moulding process.

A combination of a positive and a material connection is also conceivable, provided they do not mutually exclude one another. Thus, for example, an adhesive coating may be used in addition to corresponding latching elements on the decorative part and on the carrier part, said adhesive coating additionally connecting together the decorative part and the carrier part after the latching thereof and preferably at the same serving as a compensating mass for compensating the overall height of the antenna, so that the decorative part and the carrier part preferably bear against one another on the joining surface by a material connection and without clearance and/or without gaps, in spite of the antenna being arranged therebetween.

Moreover, a strain relief device for a cable of the antenna may be formed on the decorative part and/or on the carrier part. To this end, in particular, it may be provided that the decorative part and the carrier part are configured such that, when joining together and/or connecting the decorative part and carrier part, a clamping point for an antenna cable is produced, said clamping point being able to be used as a strain relief device. Preferably, the strain relief device is arranged on the side of the carrier part facing the bodywork when the trim part is attached as intended to the motor vehicle.

Moreover, a through-passage for passing through the antenna cable may be provided on the carrier part, the antenna cable being guided through said through-passage before the antenna is positioned on the carrier part or on the decorative part.

In order to be able to fasten the antenna and/or the antenna cable correctly to the decorative part and/or to the carrier part, fastening elements may also be provided for fastening the antenna or the antenna cable to the decorative part and/or to the carrier part. Such fastening elements may be configured, in particular, integrally with the material of the decorative part or the carrier part on the respective part. Preferably, the fastening elements are moulded in an injection-moulding process together with the decorative part and/or the carrier part inside the injection-moulding tool.

Alternatively or additionally to such fastening elements, positioning elements which also serve for specifying the position may be provided on the decorative part and/or on the carrier part for fixing the position of the antenna and/or an antenna cable in a defined manner. Such positioning elements may also be configured integrally with the material of the decorative part or of the carrier part on the respective part and also in this case the positioning elements are preferably formed in an injection-moulding process together with the decorative part and/or the carrier part inside the injection-moulding tool.

In an advantageous embodiment, positioning elements for specifying the position are provided for fixing the position of the antenna on the carrier part in a defined manner, said positioning elements being able to be transferred from a mounted position in which they protrude from the plane of an antenna carrier portion of the carrier part, into a retracted position in which the positioning elements are retracted into or behind the antenna surface facing the decorative part.

In order to permit a particularly good adhesion of the antenna on the decorative part and/or the carrier part, it may be provided that the surface of the carrier part facing the decorative part and/or the surface of the decorative part facing the carrier part is provided with an adhesive undercoat.

The antenna may, in particular, be a telephone antenna, a WiFi antenna, a Bluetooth antenna or an NFC antenna and is preferably configured as a film antenna.

Further features and advantages of the invention are disclosed from the claims and from the following description of preferred exemplary embodiments, with reference to the drawings.

### DRAWINGS

The drawings described herein are for illustration purposes only and are not intended to limit the scope of the present disclosure in any way.

FIG. 1 shows a schematic view of a motor vehicle in order to show possible positions of an external decorative part;

FIG. 2 shows a decorative part configured by way of example as an A-pillar finisher with a view of the outwardly facing decorative surface;

FIG. 3 shows the pillar finisher shown in FIG. 2 in a view of the inwardly facing surface of a carrier part;

FIG. 3a shows a detail A of FIG. 3;

FIG. 4 shows the carrier part of the decorative part shown in FIG. 2 and FIG. 3 with a film antenna positioned on an antenna carrier portion;

FIG. 4a shows a detail of a positioning element in a mounted position partially concealed by the film antenna in FIG. 4;

FIG. 4b shows a detail of a positioning element in a retracted position partially concealed by the film antenna in FIG. 4;

FIG. 5 shows a possible embodiment of fastening elements configured on the carrier part for fastening the antenna to the carrier part;

FIG. 6 shows an external decorative part configured by way of example as an aero panel with a view of the outwardly facing decorative surface;

FIG. 7 shows the carrier part of the decorative part of FIG. 6 after removing the decorative surface; and

FIG. 7a shows detail B of FIG. 7.

### DETAILED DESCRIPTION

The following description is merely exemplary in nature and is not intended to limit the present disclosure, application, or uses.

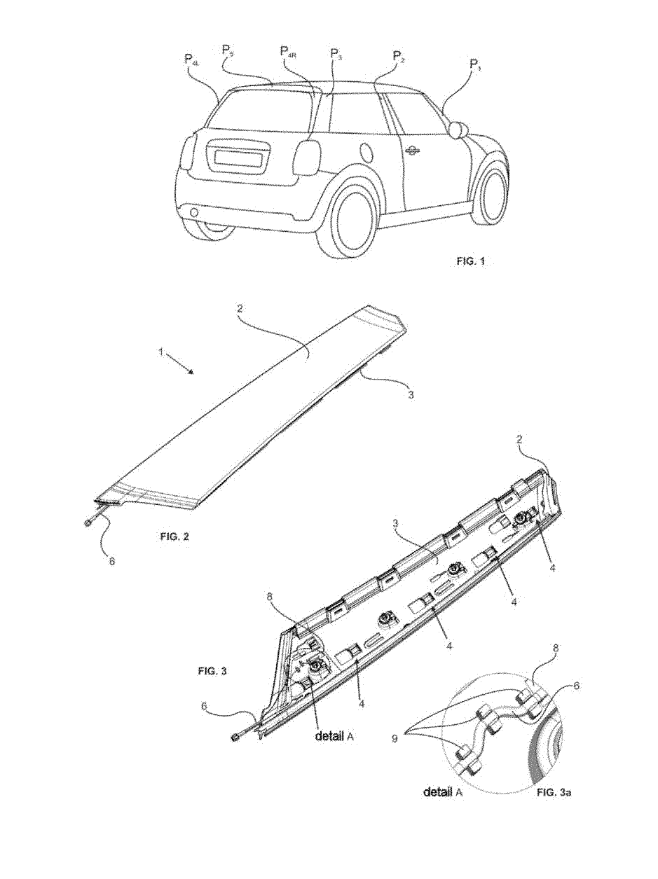

FIG. 1 shows a schematic view of a motor vehicle for showing possible positions of a decorative part, which is preferably an external decorative part which is arranged on the outer face of the vehicle bodywork. For example, the external decorative part may accordingly be an A-pillar finisher (position P1), a B-pillar finisher (position P2), a C-pillar finisher (P3), an aero panel (P4L and P4R) and/or a spoiler (P5). The invention is explained hereinafter by way of example with reference to an A-pillar finisher and an aero panel. Naturally, further positions to those shown in FIG. 1 are also conceivable.

FIG. 2 shows an external trim part 1 configured as an A-pillar finisher with a view of the outwardly facing decorative surface of a decorative part 2. This decorative surface 2, when the external trim part 1 is attached as intended to a motor vehicle, is an outward surface, i.e. a surface facing away from the vehicle, which determines the outer appearance of the motor vehicle. The decorative part 2 primarily has a visual function and is produced from a decorative material.

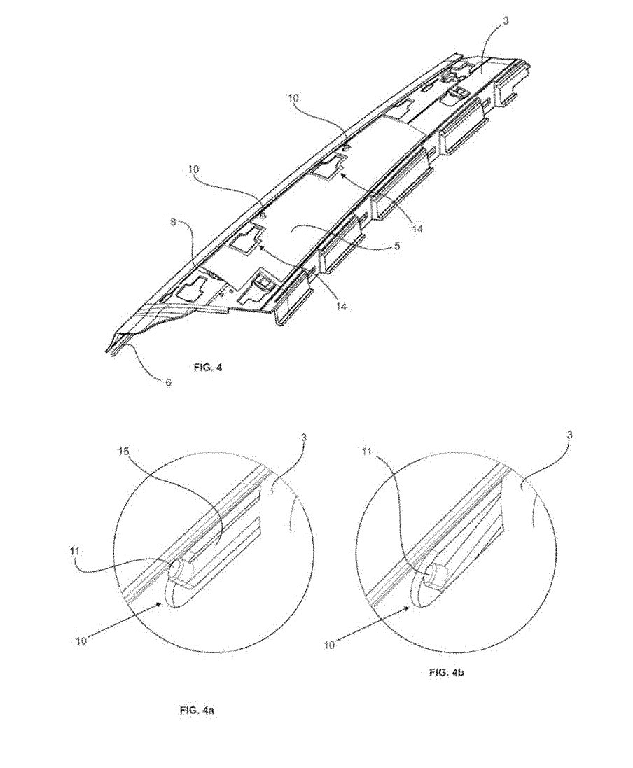

FIG. 3 shows the external decorative part 1 shown in FIG. 2, with a view of the inner face and/or rear face of the external decorative part facing inwardly (toward the vehicle bodywork). It may be identified that a carrier part 3 is arranged on the rear face of the decorative part (the face remote from the outwardly facing decorative surface). This carrier part 3 is produced from a carrier material which differs from the decorative material.

As visible from FIGS. 2 and 3, the carrier part 3 is retained on the decorative part 2 by means of mechanically acting connecting members 4 which are arranged so as to correspond to one another on the decorative part 2 and the carrier part 3, so that a gap-like intermediate space is formed with minimal gap width between the surfaces of the decorative part 2 and the carrier part 3 facing one another.

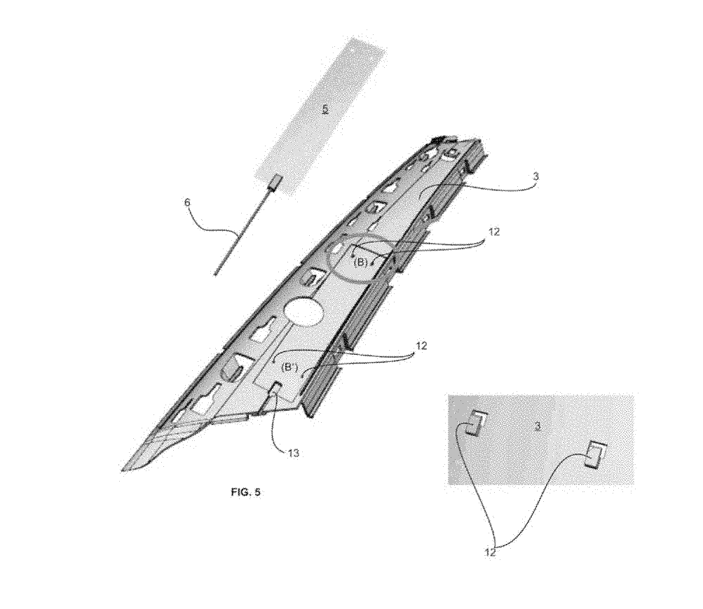

A film antenna 5 which is concealed by the carrier part in FIGS. 2 and 3 and only visible in FIG. 4 is retained by a sandwich-type connection in this gap-like intermediate space. In FIG. 2, an antenna cable 6 may be identified on the lower edge of the external decorative part, said antenna cable protruding over the outer edge of the decorative part 2. As FIG. 3 illustrates, this antenna cable 6 has been previously passed through a through-opening 7 provided in the carrier part 3. Subsequently, the antenna cable 6 is encompassed by a strain relief device 9 which is also shown in FIG. 3a as the detail A of FIG. 3. The strain relief device 9 is formed from a plurality of pairs of raised clamping projections, the spacing thereof from one another being dimensioned such that one respective pair of clamping projections encompasses in a clamped manner the antenna cable 6 which is guided between both clamping projections of the pair of clamping projections. The individual pairs of clamping projections are arranged offset relative to the respective adjacent pair of clamping projections in order to be able to divert the tensile force effectively into the carrier part when the antenna cable 6 is pulled.

FIG. 4 shows the carrier part 3 without the decorative part 2 still arranged thereon and concealing the carrier part as in FIG. 2, with a view of the surface of the carrier part 3 facing the rear face of the decorative part when the trim part is mounted as intended. A film antenna 5 is applied onto an antenna carrier portion (the portion of this surface which carries the antenna). Positioning aids in the form of two holes are provided on the film antenna 6, said positioning aids being able to be brought into congruence with positioning elements 10 which protrude from the surface of the carrier part 3 in order to predetermine the correct positioning of the film antenna 6 on the carrier part 3. Moreover, the film antenna 6 comprises lateral recesses 14 which are arranged such that the corresponding connecting members 4, which are configured on the decorative part and the carrier part, are not closed by the film antenna. In the exemplary embodiment shown in FIGS. 2 to 4, these recesses 14 keep the through-openings provided in the carrier part 3 free, the latching members provided on the decorative part engaging therein, so that the film antenna does not hinder the assembly of the decorative part and the carrier part.

FIGS. 4a and 4b show a possible embodiment of a positioning element 10. In FIG. 4a the positioning element is shown in a mounted position which the positioning element adopts when the antenna is mounted on the carrier part. In this case an elevation 11 protruding from the positioning element projects outwardly. Hole-like positioning aids in the film antenna 6 may be brought into congruence with this elevation, by the antenna 6 being arranged on the carrier part such that this elevation penetrates the positioning aid. In order to prevent this elevation, which protrudes relative to the antenna surface facing the decorative part when the trim part is assembled, from colliding with the rear face of the decorative part and/or so that the elevation does not oppose the decorative part and the carrier part being joined together in a planar manner, the elevation 11 is able to be transferred into a retracted position in which the elevation 11 acting as a positioning element is retracted relative to the antenna surface and/or the surface of the antenna carrier portion. To this end, the elevation 11 is mounted in a resilient manner which, in the exemplary embodiment shown in the figures, is ensured by a pivoting arm 15 configured integrally with the decorative part and - as shown in FIG. 4a—located in the decorative part plane or able to be transferred into this plane, said pivoting arm joining the elevation 11.

It may be provided that the mounted position shown in FIG. 4a is the position which the positioning element adopts when it is not subjected to load, wherein the positioning of the decorative part and/or the contact of the rear face thereof with the elevation 11 then forces the positioning element into the retracted position shown in FIG. 4b. Alternatively, it may be provided that the retracted position shown in FIG. 4b is the position which the positioning element adopts when it is not subjected to load, wherein when carrying out the mounting from the inner face of the carrier part (the side of the carrier part remote from the decorative part when the decorative part is assembled as intended) a mounting aid temporarily presses against the inner face in order to transfer the positioning aid into the mounted position shown in FIG. 4a, for the duration of the mounting process and/or the application of the antenna.

FIG. 5 finally illustrates a possible embodiment of the hook-shaped fastening elements 12 which are provided on the carrier part 3 and which by way of example may be provided in the region of the positions B and B′ illustrated in FIG. 5. Also in this case, holes provided in the antenna may be placed over these hook-shaped fastening elements, so that the antenna film is penetrated and encompassed by the fastening elements and—optionally in addition to an adhesive bond—is retained thereby. These fastening elements 12, therefore, not only fulfil a fastening function but serve at the same time, or—if the antenna is primarily retained by a material connection on the carrier part—substantially exclusively, as positioning elements.

FIG. 5 also shows that an indentation 13 may be provided instead of the through-opening 8 which may be identified in FIG. 3, said indentation being provided in the carrier part 3 and receiving at least one part of the antenna cable so that it does not protrude relative to the surface of the carrier part facing the decorative part when assembled as intended, but without passing through the carrier part 3. In this manner, it is also possible to prevent the antenna cable from counteracting the decorative part and the carrier part bearing against one another in a planar manner.

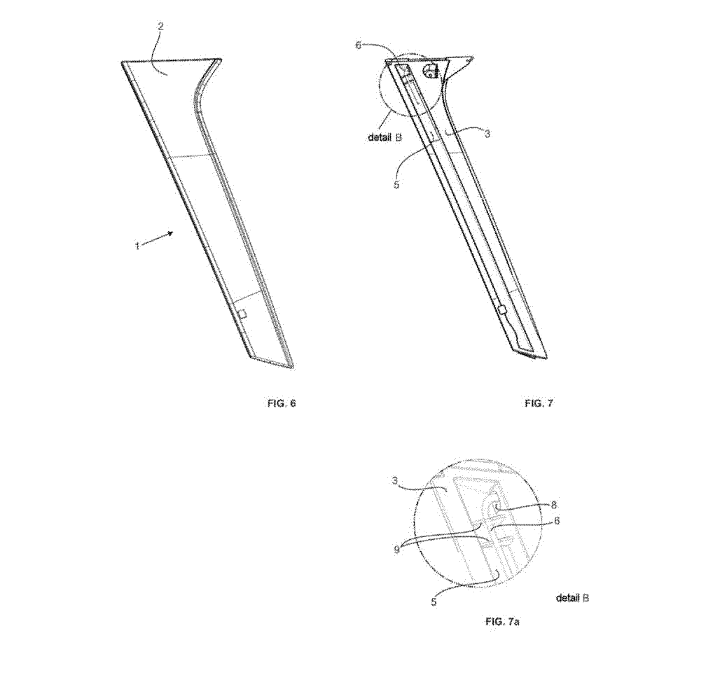

FIG. 6 shows as a further exemplary embodiment an external decorative part 1 configured as an aero panel, with a view of the outwardly facing decorative surface of a decorative part 2. The aero panel shown corresponds to the external decorative part shown in FIG. 1 at the position P4L. FIG. 7 shows the same aero panel with the decorative part removed from the carrier part 3, whereby an antenna 5 which is provided between the decorative part and the carrier part is exposed in the drawing. In detail FIG. 7a shows the detail B illustrated in FIG. 7.

From FIGS. 6 to 7a it may be seen that the antenna 5 which is arranged between the decorative part 2 and the carrier part 3 is received in the upper region of a recessed portion extending over the length of the carrier part 3. Two transverse ribs with cutouts are arranged in the recessed portion, said transverse ribs receiving the antenna cable 6 and serving as the strain relief device 9 retaining the antenna cable 6 in a clamped manner. A through-opening is arranged at the upper end of the carrier part 3, the antenna cable 6 on the side of the aero panel facing the vehicle outer surface being passed through said through-opening. The through-opening 8 is arranged such that by passing through the cable this does not counteract the surfaces which face one another of the decorative part and the carrier part bearing against one another in a planar manner.

The exemplary embodiment illustrated in FIGS. 6 to 7a shows that the antenna, when the decorative part and the carrier part are joined as intended, may also be arranged in an intermediate space which is produced between these components and the surfaces of the decorative part and the carrier part facing the antenna do not necessarily have to bear against the antenna on either side of the antenna.

Whilst the above figures have shown in each case the antenna 5 fastened to the carrier part 3, it should be mentioned that it is naturally also conceivable that the antenna is arranged on the decorative part. The details described above and relative to the carrier part may also be provided for the decorative part.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A trim part for a motor vehicle comprising:
an external decorative part and an internal carrier part which is connected to the decorative part in order to form together the trim part, wherein the decorative part is produced from a decorative material and, when the trim part is attached as intended to the motor vehicle, forms a decorative surface facing away from the bodywork and wherein the carrier part is produced from a carrier material and faces the adjacent vehicle outer surface when the trim part is attached as intended to the motor vehicle, wherein in addition to the decorative part and the carrier part, an antenna is retained between the decorative part and the carrier part or the antenna is retained on the inner face of the carrier part facing the bodywork in the installed state as intended.

2. The trim part according to claim 1, wherein the carrier material differs from the decorative material.

3. The trim part according to claim 1, wherein the surface portions of the decorative part and the carrier part facing the antenna bear in a planar manner against the antenna.

4. The trim part according to claim 1, wherein the decorative part and the carrier part are connected together via mechanical connecting members.

5. The trim part according to claim 1, wherein the decorative part and the carrier part are connected together by a material connection.

6. The trim part according to claim 1, wherein a strain relief device for a cable of the antenna is formed on the decorative part and/or on the carrier part.

7. The trim part according to claim 6, wherein the strain relief device is arranged on the inner face of the carrier part facing the bodywork when the trim part is attached as intended to the motor vehicle.

8. The trim part according to claim 1, wherein a through-passage for passing through an antenna cable is provided on the carrier part.

9. The trim part according to claim 1, wherein fastening elements are provided for fastening the antenna or an antenna cable to the decorative part and/or to the carrier part.

10. The trim part according to claim 1, wherein at least one positioning element is provided on the decorative part and/or on the carrier part for fixing the position of the antenna or an antenna cable in a defined manner.

11. The trim part according to claim 10, wherein the at least one positioning element is movable between a mounted position, in which the at least one positioning element protrudes from the plane of an antenna carrier portion of the carrier part facing toward the decorative part, and a retracted position in which it is retracted into or behind the antenna surface facing the decorative part.

12. The trim part according to claim 1, wherein the surface of the carrier part facing the decorative part and/or the surface of the decorative part facing the carrier part is at least partially provided with an adhesive undercoat.

13. The trim part according to claim 1, wherein the antenna is configured as a film antenna.

14. A method for producing a trim part having a decorative part and a carrier part which is connected to the decorative part in order to form together the trim part, wherein the decorative part is produced from a decorative material and, when the trim part is attached as intended to the motor vehicle, forms a decorative surface which faces away from the bodywork, and wherein the carrier part is produced from a carrier material and faces the bodywork when the trim part is attached as intended to the motor vehicle, the method comprising:
providing a decorative part made of a decorative material and a carrier part made of a carrier material;
attaching an antenna to the decorative part on an antenna carrier portion of the decorative part facing the carrier part or attaching the antenna to the carrier part on an antenna carrier portion of the carrier part facing the decorative part; and
joining the decorative part to the carrier part by a material and/or positive connection, encompassing the antenna between the decorative part and the carrier part.

15. A method for producing a trim part having a decorative part and a carrier part which is connected to the decorative part in order to form together the trim part, wherein the decorative part is produced from a decorative material and is aligned to face away from the bodywork, when the trim part is attached as intended to the motor vehicle, and forms a decorative surface, and wherein the carrier part is produced from a carrier material which differs from the decorative material and faces the bodywork when the trim part is attached as intended to the motor vehicle, the method comprising:
providing a decorative part made of a decorative material, attaching an antenna to the decorative part on an antenna carrier portion of the decorative part facing the carrier part when the trim part is complete, and applying the carrier material to a joining surface adjacent to the antenna carrier portion and the antenna, encompassing the antenna between the decorative material and the carrier material; or
providing a carrier part made of a carrier material, attaching an antenna to the carrier part on an antenna carrier portion of the carrier part facing the decorative part, and applying the decorative material to a joining surface adjacent to the antenna carrier portion and the antenna, encompassing the antenna between the carrier material and the decorative material.
